(19) United States
(12) Patent Application Publication
(10) Pub. No.: US 2025/0044492 A1
(43) Pub. Date: Feb. 6, 2025

(54) BACKLIGHT SYSTEM, DISPLAY SYSTEM, AND METHOD

(71) Applicant: LEIA Inc., Menlo Park, CA (US)

(72) Inventors: David A. Fattal, Mountain View, CA (US); Ming Ma, Menlo Park, CA (US)

(21) Appl. No.: 18/713,303

(22) PCT Filed: Dec. 7, 2021
(86) PCT No.: PCT/US2021/062277

§ 371 Date: May 24, 2024

(51) Int. Cl. F21V 8/00

(52) U.S. Cl. CPC G02B 6/0028; G02B 6/0045

(57) ABSTRACT

A backlight system, multiview display system, and method of backlight system operation employ light extraction elements to extract guided light from a first light guide and provide the extracted light to a second light guide. The backlight system includes the first light guide and light extraction elements spaced apart along a length of the first light guide. The light extraction elements are configured to extract portions of the guided light from the first light guide to form extracted light portions. The backlight further includes the second light guide configured to combine the extracted light received from the plurality of light extraction elements to form combined guided light. A multiview display system includes multibeam elements configured to scatter light out of multiview backlight that receives the extracted light, the scattered-out light including directional light beams having directions corresponding to view directions of the multiview display.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Electronic displays are a nearly ubiquitous medium for communicating information to users of a wide variety of devices and products. Most commonly employed electronic displays include the cathode ray tube (CRT), plasma display panels (PDP), liquid crystal displays (LCD), electroluminescent displays (EL), organic light emitting diode (OLED) and active matrix OLEDs (AMOLED) displays, electrophoretic displays (EP) and various displays that employ electromechanical or electrofluidic light modulation (e.g., digital micromirror devices, electrowetting displays, etc.). Generally, electronic displays may be categorized as either active displays (i.e., displays that emit light) or passive displays (i.e., displays that modulate light provided by another source). Among the most obvious examples of active displays are CRTs, PDPs and OLEDs/AMOLEDs. Displays that are typically classified as passive when considering emitted light are LCDs and EP displays. Passive displays, while often exhibiting attractive performance characteristics including, but not limited to, inherently low power consumption, may find somewhat limited use in many practical applications given the lack of an ability to emit light. Backlighting using light-emissive backlights may enable various passive displays such as, but not limited to, LCD and EP displays to be effectively transformed into a light emitting displays without incurring the size, complexity, power increases that often accompany the traditional active display technologies.

### BRIEF DESCRIPTION OF THE DRAWINGS

Various features of examples and embodiments in accordance with the principles described herein may be more readily understood with reference to the following detailed description taken in conjunction with the accompanying drawings, where like reference numerals designate like structural elements, and in which:

FIG. 1 illustrates a perspective view of a multiview display in an example, according to an embodiment consistent with the principles described herein.

FIG. 2 illustrates a graphical representation of the angular components of a light beam having a particular principal angular direction corresponding to a view direction of a multiview display in an example, according to an embodiment consistent with the principles described herein.

FIG. 3A illustrates a perspective view of a backlight system in an example, according to an embodiment consistent with the principles described herein.

FIG. 3B illustrates a plan view of a backlight system in an example, according to an embodiment consistent with the principles described herein.

FIG. 3C illustrates a plan view of a backlight system in an example, according to another embodiment consistent with the principles described herein.

FIG. 4A illustrates a top view of a portion of a backlight system in an example, according to an embodiment consistent with the principles described herein.

FIG. 4B illustrates a top view of a portion of a backlight system in an example, according to another embodiment consistent with the principles described herein.

FIG. 4C illustrates a top view of a portion of a backlight system in an example, according to yet another embodiment consistent with the principles described herein.

FIG. 5 illustrates a block diagram of multiview display system in an example, according to an embodiment of the principles described herein.

FIG. 6 illustrates a method of backlight system operation in an example, according to an embodiment of the principles described herein.

Certain examples and embodiments have other features that are one of in addition to and in lieu of the features illustrated in the above-referenced figures. These and other features are detailed below with reference to the above-referenced figures.

### DETAILED DESCRIPTION

Embodiments and examples in accordance with the principles described herein provide a backlighting that employs various light extraction elements to extracts light from a first light guide and provides the extracted light to a second light guide that may be used as a backlight in a display. In particular, according to various embodiments of the principles described herein a backlight system is provided that includes a plurality of light extraction elements distributed along an edge or side of the first light guide to extract portions of light guided in the first light guide. The extracted portions of light are then directed into the second backlight where the extracted portions are combined together as combined guide light to illuminate the second light guide. is provided that includes a light guide configured to receive light at an end of the light guide and to guide the received light along a length of the light guide as guided light. The combined guided light may be scattered out of the second light guide as emitted light for use in a display.

Compared with a single-light guide system, which may include a row of discrete light sources (e.g., light-emitting diodes) spaced along an edge of a plate light guide, the backlight system described herein may reduce or consolidate a number of discrete light sources required to fully illuminate the plate light guide. For example, the plurality of light sources may be reduced to one or perhaps two discrete light sources. In turn, power consumption as well as the complexity electrical connections used to power and control the light source may also be reduced. Further, using the first light guide to distribute light along an edge of the second light guide may help randomize and homogenize the light that is delivered to the second light guide, which may improve a uniformity of the light within and emitted by the backlight system. For example, using the first light guide to distribute light along an edge of the second light guide may help mask non-uniformities in intensity and/or color temperature that otherwise my pose a problem when discrete light sources are used.

Herein a ‘two-dimensional display’ or ‘2D display’ is defined as a display configured to provide a view of an image that is substantially the same regardless of a direction from which the image is viewed (i.e., within a predefined viewing angle or range of the 2D display). A conventional liquid crystal display (LCD) found in many smart phones and computer monitors are examples of 2D displays. In contrast herein, a ‘multiview display’ is defined as an electronic display or display system configured to provide different views of a multiview image in or from different view directions. In particular, the different views may represent different perspective views of a scene or object of the multiview image. Uses of unilateral backlighting and unilateral multiview displays described herein include, but are not limited to, mobile telephones (e.g., smart phones), watches, tablet computers, mobile computers (e.g., laptop computers), personal computers and computer monitors, automobile display consoles, camera displays, and various other mobile as well as substantially non-mobile display applications and devices.

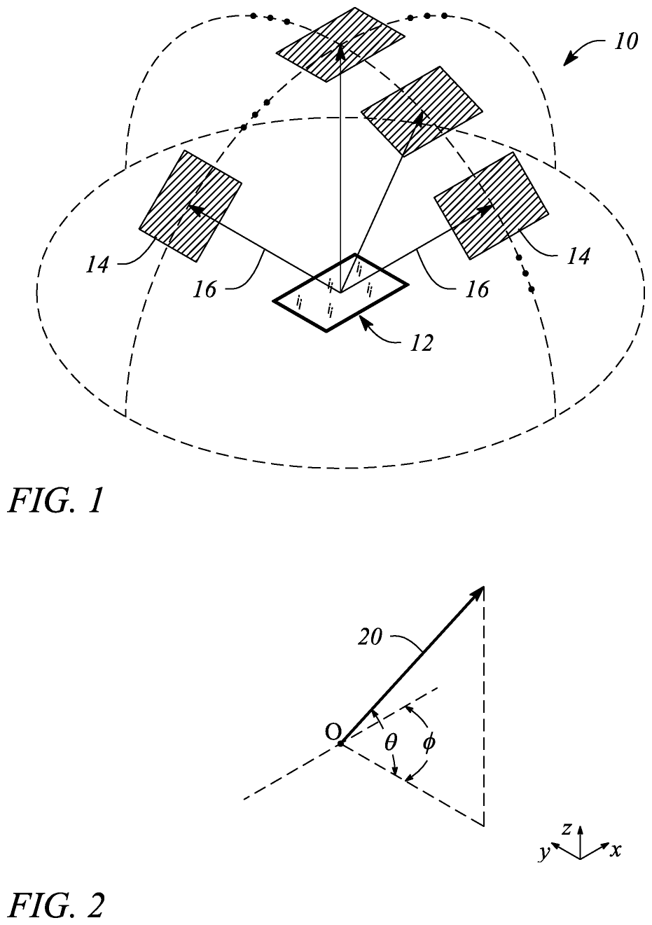

FIG. 1 illustrates a perspective view of a multiview display 10 in an example, according to an embodiment consistent with the principles described herein. As illustrated in FIG. 1, the multiview display 10 comprises a screen 12 to display a multiview image to be viewed. The screen 12 may be a display screen of a telephone (e.g., mobile telephone, smart phone, etc.), a tablet computer, a laptop computer, a computer monitor of a desktop computer, a camera display, or an electronic display of substantially any other device, for example.

The multiview display 10 provides different views 14 of the multiview image in different view directions 16 relative to the screen 12. The view directions 16 are illustrated as arrows extending from the screen 12 in various different principal angular directions. The different views 14 are illustrated as shaded polygonal boxes at the termination of the arrows (i.e., depicting the view directions 16). Only four views 14 and four view directions 16 are illustrated, all by way of example and not limitation. While the different views 14 are illustrated in FIG. 1 as being above the screen, the views 14 actually appear on or in a vicinity of the screen 12 when the multiview image is displayed on the multiview display 10. Depicting the views 14 above the screen 12 is only for simplicity of illustration and is meant to represent viewing the multiview display 10 from a respective one of the view directions 16 corresponding to a particular view 14. A 2D display may be substantially similar to the multiview display 10, except that the 2D Display is generally configured to provide a single view (e.g., one view similar to view 14) of a displayed image as opposed to the different views 14 of the multiview image provided by the multiview display 10.

A view direction or equivalently a light beam having a direction corresponding to a view direction of a multiview display generally has a principal angular direction given by angular components {θ, ϕ}, by definition herein. The angular component θ is referred to herein as the ‘elevation component’ or ‘elevation angle’ of the light beam. The angular component ϕ is referred to as the ‘azimuth component’ or ‘azimuth angle’ of the light beam. By definition, the elevation angle θ is an angle in a vertical plane (e.g., perpendicular to a plane of the multiview display screen while the azimuth angle ϕ is an angle in a horizontal plane (e.g., parallel to the multiview display screen plane).

FIG. 2 illustrates a graphical representation of the angular components {θ, ϕ} of a light beam 20 having a particular principal angular direction corresponding to a view direction (e.g., view direction 16 in FIG. 1) of a multiview display in an example, according to an embodiment consistent with the principles described herein. In addition, the light beam 20 is emitted or emanates from a particular point, by definition herein. That is, by definition, the light beam 20 has a central ray associated with a particular point of origin within the multiview display. FIG. 2 also illustrates the light beam (or view direction) point of origin O.

Herein, a ‘light guide’ is defined as a structure that guides light within the structure using total internal reflection. In particular, the light guide may include a core that is substantially transparent at an operational wavelength of the light guide. The term ‘light guide’ generally refers to a dielectric optical waveguide that employs total internal reflection to guide light at an interface between a dielectric material of the light guide and a material or medium that surrounds that light guide. By definition, a condition for total internal reflection is that a refractive index of the light guide is greater than a refractive index of a surrounding medium adjacent to a surface of the light guide material. In some embodiments, the light guide may include a coating in addition to or instead of the aforementioned refractive index difference to further facilitate the total internal reflection. The coating may be a reflective coating, for example. The light guide may be any of several light guides including, but not limited to, one or both of a plate or slab guide and a strip guide.

Further herein, the term ‘plate’ when applied to a light guide as in a ‘plate light guide’ is defined as a piecewise or differentially planar layer or sheet, which is sometimes referred to as a ‘slab’ guide. In particular, a plate light guide is defined as a light guide configured to guide light in two substantially orthogonal directions bounded by a top surface and a bottom surface (i.e., opposite surfaces) of the light guide. Further, by definition herein, the top and bottom surfaces are both separated from one another and may be substantially parallel to one another in at least a differential sense. That is, within any differentially small section of the plate light guide, the top and bottom surfaces are substantially parallel or co-planar.

In some embodiments, the plate light guide may be substantially flat (i.e., confined to a plane) and therefore, the plate light guide is a planar light guide. In other embodiments, the plate light guide may be curved in one or two orthogonal dimensions. For example, the plate light guide may be curved in a single dimension to form a cylindrical shaped plate light guide. However, any curvature has a radius of curvature sufficiently large to ensure that total internal reflection is maintained within the plate light guide to guide light.

Herein, a ‘diffraction grating’ is generally defined as a plurality of features (i.e., diffractive features) arranged to provide diffraction of light incident on the diffraction grating. In some examples, the plurality of features may be arranged in a periodic or quasi-periodic manner. For example, the diffraction grating may include a plurality of features (e.g., a plurality of grooves or ridges in a material surface) arranged in a one-dimensional (1D) array. In other examples, the diffraction grating may be a two-dimensional (2D) array of features. The diffraction grating may be a 2D array of bumps on or holes in a material surface, for example.

As such, and by definition herein, the ‘diffraction grating’ is a structure that provides diffraction of light incident on the diffraction grating. If the light is incident on the diffraction grating from a light guide, the provided diffraction or diffractive scattering may result in, and thus be referred to as, ‘diffractive coupling’ in that the diffraction grating may couple light out of the light guide by diffraction. The diffraction grating also redirects or changes an angle of the light by diffraction (i.e., at a diffractive angle). In particular, as a result of diffraction, light leaving the diffraction grating generally has a different propagation direction than a propagation direction of the light incident on the diffraction grating (i.e., incident light). The change in the propagation direction of the light by diffraction is referred to as ‘diffractive redirection’ herein. Hence, the diffraction grating may be understood to be a structure including diffractive features that diffractively redirects light incident on the diffraction grating and, if the light is incident from a light guide, the diffraction grating may also diffractively couple out the light from the light guide.

Further, by definition herein, the features of a diffraction grating are referred to as ‘diffractive features’ and may be one or more of at, in, and on a material surface (i.e., a boundary between two materials). The surface may be a surface of a light guide, for example. The diffractive features may include any of a variety of structures that diffract light including, but not limited to, one or more of grooves, ridges, holes and bumps at, in or on the surface. For example, the diffraction grating may include a plurality of substantially parallel grooves in the material surface. In another example, the diffraction grating may include a plurality of parallel ridges rising out of the material surface. The diffractive features (e.g., grooves, ridges, holes, bumps, etc.) may have any of a variety of cross-sectional shapes or profiles that provide diffraction including, but not limited to, one or more of a sinusoidal profile, a rectangular profile (e.g., a binary diffraction grating), a triangular profile and a saw tooth profile (e.g., a blazed grating).

According to various examples described herein, a diffraction grating (e.g., a diffraction grating of a multibeam element, as described below) may be employed to diffractively scatter or couple light out of a light guide (e.g., a plate light guide) as a light beam. In particular, a diffraction angle θₘ of or provided by a locally periodic diffraction grating may be given by equation (1) as:

$${θ}_{m} = {sin}^{- 1} ( n sin {θ}_{i} - \frac{m λ}{d} ) \qquad ( 1 )$$

where λ is a wavelength of the light, m is a diffraction order, n is an index of refraction of a light guide, d is a distance or spacing between features of the diffraction grating, θᵢ is an angle of incidence of light on the diffraction grating. For simplicity, equation (1) assumes that the diffraction grating is adjacent to a surface of the light guide and a refractive index of a material outside of the light guide is equal to one (i.e., nₒᵤₜ=1). In general, the diffraction order m is given by an integer. A diffraction angle θₘ of a light beam produced by the diffraction grating may be given by equation (1) where the diffraction order is positive (e.g., m>0). For example, first-order diffraction is provided when the diffraction order m is equal to one (i.e., m=1).

By definition herein, a ‘multibeam element’ is a structure or element of a backlight or a display that produces light that includes a plurality of directional light beams. In some embodiments, the multibeam element may be optically coupled to a light guide of a backlight to provide the light beams by coupling out a portion of light guided in the light guide. Further, the light beams of the plurality of light beams produced by a multibeam element have different principal angular directions from one another, by definition herein. In particular, by definition, a light beam of the plurality has a predetermined principal angular direction that is different from another light beam of the light beam plurality. Furthermore, the light beam plurality may represent a light field. For example, the light beam plurality may be confined to a substantially conical region of space or have a predetermined angular spread that includes the different principal angular directions of the light beams in the light beam plurality. As such, the predetermined angular spread of the light beams in combination (i.e., the light beam plurality) may represent the light field. According to various embodiments, the different principal angular directions of the various light beams are determined by a characteristic including, but not limited to, a size (e.g., length, width, area, etc.) of the multibeam element. In some embodiments, the multibeam element may be considered an ‘extended point source’, i.e., a plurality of point light sources distributed across an extent of the multibeam element, by definition herein.

Herein, the ‘size’ may be defined in any of a variety of manners to include, but not be limited to, a length, a width or an area. For example, the size of the multibeam element may be a length of the multibeam element. In another example, size may refer to an area of the multibeam element. In some embodiments, the size of the multibeam element is comparable to a size of a light valve used to modulate directional light beams of the plurality of directional light beams. As such, the multibeam element size may be comparable to a light valve size when the multibeam element size is between about twenty-five percent (25%) and about two hundred percent (200%) of the light valve size. For example, if the multibeam element size is denoted ‘s’ and the light valve size is denoted ‘S’, then the multibeam element size s may be given by equation (2) as:

$$\frac{1}{4} S \leq s \leq S \qquad ( 2 )$$

In other examples, the multibeam element size is greater than about fifty percent (50%) of the light valve size, or about sixty percent (60%) of the light valve size, or about seventy percent (70%) of the light valve size, or greater than about eighty percent (80%) of the light valve size, or greater than about ninety percent (90%) of the light valve size, and the multibeam element is less than about one hundred eighty percent (180%) of the light valve size, or less than about one hundred sixty percent (160%) of the light valve size, or less than about one hundred forty (140%) of the light valve size, or less than about one hundred twenty percent (120%) of the light valve size. For example, the multibeam element may be comparable in size to the light valve size where the multibeam element size is between about seventy-five percent (75%) and about one hundred fifty percent (150%) of the light valve size. In another example, the multibeam element and light valve may be comparable in size where the multibeam element size is between about one hundred twenty-five percent (125%) and about eighty-five percent (85%) of the light valve size. According to some embodiments, the comparable sizes of the multibeam element and the light valve may be chosen to reduce, or in some examples to minimize, dark zones between views of the multiview display, while at the same time reducing, or in some examples minimizing, an overlap between views of the multiview display.

Herein, a ‘collimation factor’ is defined as a degree to which light is collimated. In particular, a collimation factor defines an angular spread of light rays within a collimated beam of light, by definition herein. For example, a collimation factor a may specify that a majority of light rays in a beam of collimated light is within a particular angular spread (e.g., +/−σ degrees about a central or principal angular direction of the collimated light beam). The light rays of the collimated light beam may have a Gaussian distribution in terms of angle and the angular spread may be an angle determined by at one-half of a peak intensity of the collimated light beam, according to some examples.

Herein, a ‘light source’ is defined as a source of light (e.g., an optical emitter configured to produce and emit light). For example, the light source may comprise an optical emitter such as a light emitting diode (LED) that emits light when activated or turned on. In particular, herein the light source may be substantially any source of light or comprise substantially any optical emitter including, but not limited to, one or more of a light emitting diode (LED), a laser, an organic light emitting diode (OLED), a polymer light emitting diode, a plasma-based optical emitter, a fluorescent lamp, an incandescent lamp, and virtually any other source of light. The light produced by the light source may have a color (i.e., may include a particular wavelength of light), or may be a range of wavelengths (e.g., white light). In some embodiments, the light source may comprise a plurality of optical emitters. For example, the light source may include a set or group of optical emitters in which at least one of the optical emitters produces light having a color, or equivalently a wavelength, that differs from a color or wavelength of light produced by at least one other optical emitter of the set or group. The different colors may include primary colors (e.g., red, green, blue) for example.

Further, as used herein, the article ‘a’ is intended to have its ordinary meaning in the patent arts, namely ‘one or more’. For example, ‘a light extraction element’ means one or more light extraction elements and as such, ‘the light extraction element’ means ‘light extraction element (s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means within the tolerance range of the equipment used to produce the value, or may mean plus or minus 10%, or plus or minus 5%, or plus or minus 1%, unless otherwise expressly specified. Further, the terms ‘substantially’ and ‘about,’ as used herein, mean a majority, or almost all, or all, or an amount within a range of about 51% to about 100%. Moreover, examples herein are intended to be illustrative only and are presented for discussion purposes and not by way of limitation.

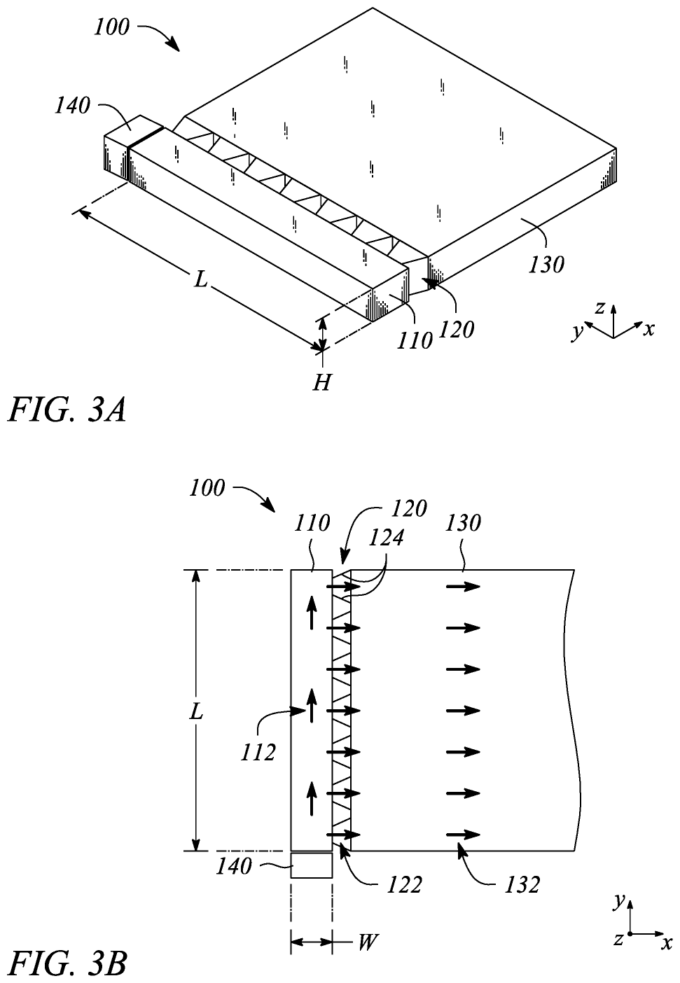

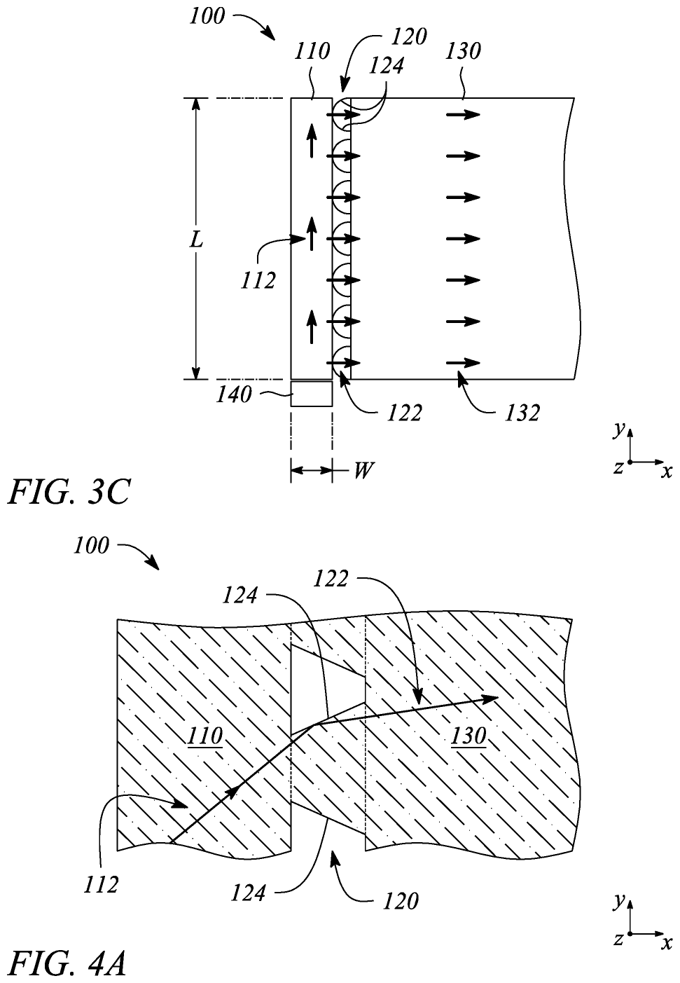

In some embodiments of the principles described herein, a backlight system is provided. FIG. 3A illustrates a perspective view of a backlight system 100 in an example, according to an embodiment consistent with the principles described herein. FIG. 3B illustrates a plan view of a backlight system 100 in an example, according to an embodiment consistent with the principles described herein. FIG. 3C illustrates a plan view of a backlight system 100 in an example, according to another embodiment consistent with the principles described herein.

As illustrated, the backlight system 100 comprises a first light guide 110. The first light guide 110 is configured to guide light along a length of the first light guide 110 as guided light 112. According to various embodiments, the guided light 112 is guided according to total internal reflection within the first light guide 110. For example, the first light guide 110 may include a dielectric material configured as an optical waveguide. The dielectric material of the optical waveguide may have a first refractive index that is greater than a second refractive index of a medium surrounding the dielectric optical waveguide. The difference in refractive indices is configured to facilitate total internal reflection of the guided light 112 according to one or more guided modes of the first light guide 110.

According to various embodiments, the optically transparent, dielectric material of the first light guide 110 may include or be made up of any of a variety of dielectric materials including, but not limited to, one or more of various types of glass (e.g., silica glass, alkali-aluminosilicate glass, borosilicate glass, etc.), one or more substantially optically transparent plastics or polymers (e.g., poly(methyl methacrylate) or ‘acrylic glass’, polycarbonate, etc.) or a combination thereof. In some embodiments, the first light guide 110 may further include a cladding layer (not illustrated) on at least a portion of a surface (e.g., one or more of a top surface, a side surface, and a bottom surface) of the first light guide 110. The cladding layer may be used to further facilitate total internal reflection, according to some examples.

In various embodiments, the first light guide 110 is or comprises a bar-shaped, columnar optical waveguide, e.g., as illustrated in FIGS. 3A-3C. In particular, as illustrated the first light guide 110 has a bar shape with a length L in a y-direction that is greater than both a width Win an x-direction and height H in a z-direction (i.e., L>W and L>H). As mentioned above, the guided light 112 is guided along the length L and may be guided in either direction along the length. For example, the guided light 112 may be guided within the first light guide 110 from a first end toward a second end or from the second end toward the first end or from each of the first and second ends, according to various embodiments.

As illustrated in FIGS. 3A-3C, the backlight system 100 further comprises a plurality of light extraction elements 120 spaced apart from one another along the length of the first light guide 110. Light extraction elements 120 of the light extraction element plurality are each configured to extract respective portions of the guided light 112 from the first light guide 110 to form extracted light portions 122. In FIGS. 3A-3C, the extracted light portions 122 are depicted as arrows with the understanding that the arrows merely represent light or light beams of the extracted light portions 122. For example, an illustrated arrow may represent a single beam of light of the extracted light portions 122.

The backlight system 100 illustrated in FIGS. 3A-3C further comprises a second light guide 130. The second light guide 130 is configured to combine the extracted light portions 122 to form combined guided light 132. The second light guide 130 is further configured to guide the combined guided light 132 along a length of the second light guide 130 away from the plurality of light extraction elements 120 and the first light guide 110. In some embodiments, the second light guide 130 may be further configured to emit the combined guided light 132 or a portion thereof as emitted light 134, as is further described below. For example, the second light guide 130 may be used as a backlight to illuminate a display using the emitted portion of the combined guided light 132.

According to various embodiments, the second light guide 130 may be substantially similar to the first light guide 110. That is the second light guide 130 is configured to guide light according to total internal reflection within an optically transparent dielectric material configured as an optical waveguide. The optically transparent, dielectric material of the second light guide 130 may include or be made up of any of a variety of dielectric materials including, but not limited to, one or more of various types of glass (e.g., silica glass, alkali-aluminosilicate glass, borosilicate glass, etc.), one or more substantially optically transparent plastics or polymers (e.g., poly(methyl methacrylate) or ‘acrylic glass’, polycarbonate, etc.) or a combination thereof. In some embodiments, the second light guide 130 may further include a cladding layer (not illustrated) on at least a portion of a surface (e.g., one or more of a top surface, a side surface, and a bottom surface) of the first light guide 110. The cladding layer may be used to further facilitate total internal reflection, according to some examples.

In some embodiments, the second light guide 130 is planar or substantially planar (i.e., a plate light guide) and extends over a rectangular area. In other embodiments, the second light guide 130 may a shape other than rectangular including, but not limited to, a hexagonal shape and a triangular shape. In these embodiments, the first light guide 110 may extend along at least portion of an edge of the second light guide 130, e.g., along an edge of the rectangular area or shape of the second light guide 130 as illustrated in FIGS. 3A-3C.

In some embodiments, the second light guide 130 may comprise a plurality of scattering features distributed across a region of second light guide 130. For example, the scattering features may be distributed over the rectangular area of the second light guide 130. The scattering features are configured to scatter out a portion of the combined guided light 132 from the second light guide 130 as emitted light. In some embodiments, a scattering feature of the plurality of scattering features comprises a multibeam element. The multibeam element is configured to scatter out from the second light guide 130 a portion of the combined guided light 132 as a plurality of directional light beams having different principal angular directions corresponding to respective different view directions of a multiview display. In some embodiments, the scattering feature comprises an array of multibeam elements as is described in more detail below.

According to various embodiments, a light extraction element 120 of the plurality of light extraction elements 120 comprises a sidewall 124 configured to reflect a corresponding extracted light portion 122 toward the second light guide 130. In some embodiments, the sidewall 124 of the light extraction element 120 has a straight shape or comprises a straight or substantially straight reflective surface. For example, the light extraction elements 120 illustrated in FIGS. 3A and 3B have sidewalls 124 with a straight shape, i.e., comprise straight sidewalls 124. In other embodiments, the sidewall 124 of the light extraction element has a curved shape. For example, the curved shape of the sidewall 124 may be circular or semi-circular, as illustrated in FIG. 3C. In another example, the curved shape may comprise a parabolic curve or a hyperbolic curve. In yet other embodiments, the sidewall 124 may have a complex shape such as, but not limited to, a piecewise linear or piecewise curved shape, i.e., may comprise a plurality of straight sections (piecewise linear) or a plurality of curved sections (piecewise curved) that approximate a curved shape or even another complex shape.

According to some embodiments, the sidewall 124 of the light extraction element 120 is configured to reflect the extracted light portion 122 according to total internal reflection. That is, the light extraction element 120 acts as a light guide to guide the extracted light portion 122 using total internal reflection at the sidewall 124. In other embodiments, the sidewall 124 of the light extraction element 120 comprises a reflective material configured to reflect the extracted light portion 122. In yet other embodiments, the sidewall 124 is configured to reflect the extracted light portion 122 using both total internal reflection and a reflective material of the sidewall 124, e.g., a reflective cladding.

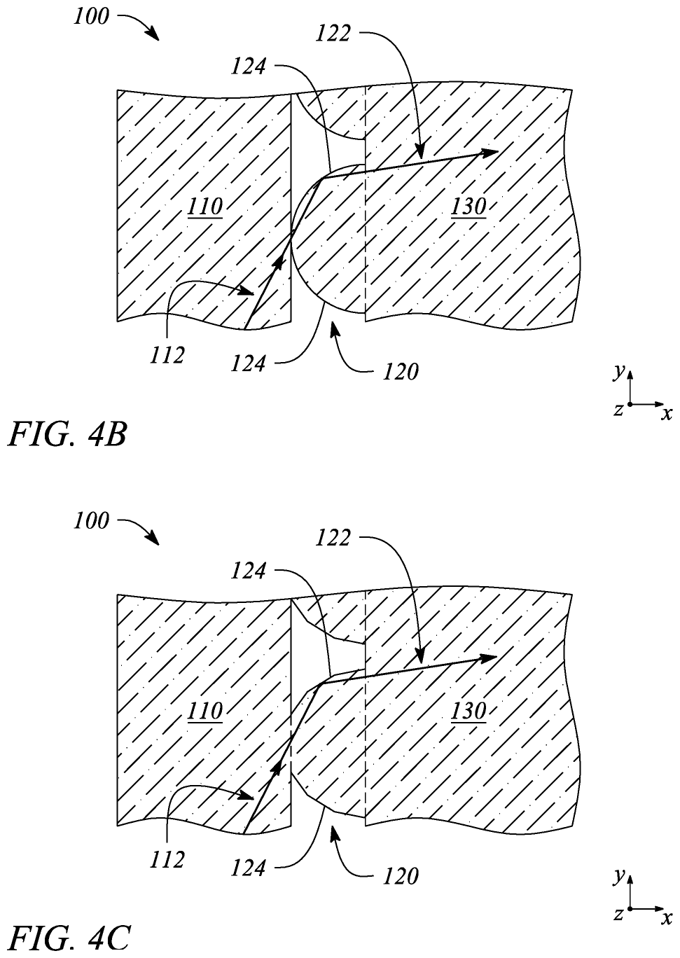

FIG. 4A illustrates a top view of a portion of a backlight system 100 in an example, according to an embodiment consistent with the principles described herein. As illustrated, the portion of the backlight system 100 includes the first light guide 110, a light extraction element 120, and the second light guide 130. The light extraction element 120 illustrated in FIG. 4A has sidewalls 124 that are straight or substantially straight. In addition, the straight sidewalls 124 are angled or sloped relative to a surface normal of a side the first light guide 110 as well as a surface normal of an edge or end of the second light guide 130, as illustrated. That is, the sidewalls 124 are angled or tilted in ay-direction such that the light extraction element 120 is narrower or has a smaller aperture at an end adjacent to the first light guide 110 and wider or has a larger aperture at an end opposite to the first light guide adjacent end, e.g., an end adjacent to a second light guide 130, described below. FIG. 4A also illustrates guided light 112 entering the light extraction element 120 and being reflected by the sidewall 124 to exit the light extraction element 120 as the extracted light portion 122. As mentioned above, FIGS. 3A-3B also illustrates light extraction elements 120 having curved sidewalls 124.

FIG. 4B illustrates a top view of a portion of a backlight system 100 in an example, according to another embodiment consistent with the principles described herein. The portion of the backlight system 100 illustrated in FIG. 4B includes the first light guide 110, the second light guide 130, and a light extraction element 120 having sidewalls 124 that are curved. According to various embodiments, the curved sidewalls 124 may have a semi-circular curved shape, e.g., as illustrated. As in FIG. 4A, the light extraction element 120 illustrated in FIG. 4B has an aperture adjacent to the first light guide 110 that is smaller than an aperture of the light extraction element 120 at the opposite end of the light extraction element 120. In some embodiments, the aperture adjacent to the first light guide 110 may be or represent a point contact between the first light guide 110 and the light extraction element 120 that is tangent to the semi-circular shape of the sidewall 124 at end of the light extraction element 120, e.g., as illustrated. Guided light 112 is illustrated in FIG. 4B entering the light extraction element 120 and being reflected by the curved sidewall 124 to exit the light extraction element 120 as the extracted light portion 122. FIG. 3C also illustrates light extraction elements 120 having curved sidewalls 124, as mentioned above.

FIG. 4C illustrates a top view of a portion of a backlight system 100 in an example, according to yet another embodiment consistent with the principles described herein. As in FIGS. 4A-4B, the portion of the backlight system 100 includes the first light guide 110, a light extraction element 120, and the second light guide 130. In FIG. 4C, the light extraction element 120 has sidewalls 124 that are piecewise linear. That is, the piecewise linear sidewalls 124 comprise a plurality of straight segments that combine to approximate a curved surface or shape, as illustrated. Again, an aperture of the light extraction element 120 adjacent to the first light guide 110 is smaller than an aperture of the light extraction element 120 at the opposite end of the light extraction element 120, as illustrated in FIG. 4C. Also illustrated in FIG. 4C is guided light 112 entering the light extraction element 120 and being reflected by the sidewall 124 to exit the light extraction element 120 as the extracted light portion 122.

As mentioned above with respect to each of FIGS. 4A-4C, a portion of the guided light 112 may enter the light extraction element 120 at a first propagation angle from the first light guide 110. The sidewall 124 then reflect reflects the portion of the guided light 112 to provide the extracted light portion 122 at a different, second propagation angle after the reflection. As a result of the angle or curve of the sidewall 124, the second propagation angle may be less than the first propagation angle relative to the surface normal of the end or edge of the first light guide 110, according to various embodiments (e.g., as illustrated).

In some embodiments, the light extraction elements 120 may be directly adjacent to one another. That is, there is no or substantially no space between adjacent light extraction elements 120. In other embodiments, adjacent light extraction elements 120 of the plurality of light extraction elements 120 are spaced apart by air gaps along the length of the first light guide 110. According to some embodiments, a size of individual light extraction elements 120 is between about five (5 μm) micrometers and about five hundred micrometers (500 μm). In other embodiments, a size of individual light extraction elements 120 is between about ten micrometers (10 μm) and about three hundred micrometers (300 μm). Smaller light extraction elements 120, for example, those less than about fifty (50) μm or one hundred (100 μm), may facilitate a denser distribution of light extraction element 120 along the length of the first light guide 110. A denser distribution may provide more uniformity to the combined guided light 132, for example. On the other hand, larger light extraction elements 120, for example, those greater than about two hundred micrometers (200 μm) may improve or facilitate manufacturability.

According to various embodiments, a light extraction element 120 comprises a dielectric material such as, but not limited to, an optically transparent dielectric material. In some embodiments, a light extraction element 120 of the plurality of light extraction elements 120 is integral to the second light guide 130, while being separate from the first light guide 110. In these embodiments, the light extraction element 120 may contact an edge of the first light guide 110 to provide light extraction at an area of contact between the light extraction element 120 and the first light guide 110. In other embodiments, a light extraction element 120 of the plurality of light extraction elements 120 is integral to the first light guide 110. In these embodiments, an aperture at an input of the light extraction element 120 is configured to provide light extraction from the first light guide 110. Further, the light extraction element 120 may contact the edge of the second light guide 130, in some embodiments. In yet other embodiments, the plurality of light extraction elements 120 is a structure that is separate from both the first and second light guides 110, 130. In these embodiments, the plurality of light extraction elements 120 may be sandwiched or otherwise positioned between the first light guide 110 and the second light guide 130.

In some of these embodiments, the combined guided light 132 may have a predetermined collimation factor determined by the plurality of light extraction elements 120. In particular, in some embodiments the plurality of light extraction elements 120 is configured to collimate the extracted light portions 122 and provide the collimated extracted light portions 122 to the second light guide 130 to be guided as collimated combined guided light 132. In some embodiments, the light extraction elements 120 collimate extracted light portions 122 according to a predetermined collimation factor a.

In some embodiments (e.g., as illustrated in FIGS. 3A-3C), the backlight system 100 further comprises a light source 140. The light source 140 is configured to provide light to the first light guide 110 to be guided as the guided light 112. In some embodiments, the light source 140 is disposed at an end of the first light guide 110 and the plurality of light extraction elements 120 is disposed on a side of the first light guide 110 that is orthogonal to the end. In these embodiments, the light source 140 is configured to provide light through the end of the first light guide 110. In some embodiments, the light source 140 may comprise two portions, one at each end of the first light guide 110. In these embodiments, the light source 140 may provide light to both ends of the first light guide 110. In some embodiments, the light source 140 may comprise a light emitting diode.

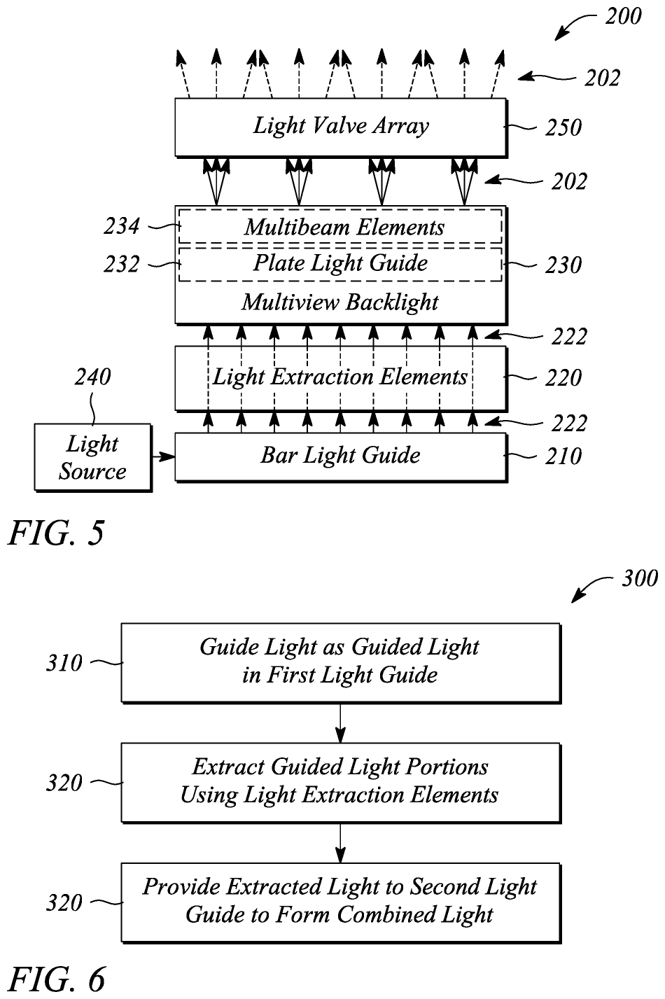

Embodiments of the principles described herein, further provide a display system and more particularly a multiview display system that may employ various portions or elements of the backlight system 100, described above. FIG. 5 illustrates a block diagram of multiview display system 200 in an example, according to an embodiment of the principles described herein. As illustrated, the multiview display system 200 comprises a bar light guide 210. The bar light guide 210 is configured to guide light as guided light. In some embodiments, the bar light guide 210 may be substantially similar to the first light guide 110 described above with respect to the backlight system 100.

The multiview display system 200 illustrated in FIG. 5 further comprises a plurality of light extraction elements 220. The plurality of light extraction elements 220 are disposed and spaced apart from one another along a side of the bar light guide 210. According to various embodiments, the plurality of light extraction elements 220 is configured to extract portions of the guided light from the bar light guide 210 to form extracted light portions 222. In some embodiments, the plurality of light extraction elements 220 may be substantially similar to the plurality of light extraction elements 120 of the above-described backlight system 100.

In particular, in some embodiments a light extraction element 220 of the plurality of light extraction elements 220 may comprises a sidewall configured to reflect a corresponding extracted light portion toward a plate light guide at an output of the light extraction element 220. For example, the plate light guide may be a plate light guide of a multiview backlight described below. In various embodiments, the sidewall may have one of a curved shape and a straight shape, e.g., as illustrated above in FIGS. 4A-4C. In various embodiments, a light extraction element 220 of the plurality of light extraction elements 220 may be one or more of integral to the plate light guide, integral to the bar light guide 210, and a separate element from both of the plate light guide and the bar light guide 210, e.g., sandwiched between the plate light guide and the bar light guide 210.

As illustrated in FIG. 5, the multiview display system 200 further comprises a multiview backlight 230. The multiview backlight 230 comprises a plate light guide 232 and a plurality of multibeam elements 234. In some embodiments, the plate light guide 232 may be substantially similar to the second light guide 130 of the backlight system 100, described above. In particular, the plate light guide 232 is configured to combine the extracted light portions 222 to form combined guided light. In turn, the plurality of multibeam elements 234 is configured to scatter out the combined guided light from the plate light guide as directional light beams 202 having directions corresponding to view directions of the multiview display system 200 or equivalently directions corresponding views of a multiview image displayed by the multiview display system 200.

According to various embodiments, the multibeam elements 234 may comprise any of a number of different structures configured to scatter out a portion of the guided light from the plate light guide 232. For example, the different structures may include, but are not limited to, diffraction gratings, micro-reflective elements, micro-refractive elements, or various combinations thereof. In some embodiments, the multibeam element 234 comprising a diffraction grating is configured to diffractively scatter out the guided light portion as the plurality of directional light beams 202 having the different principal angular directions. In other embodiments, the multibeam element 234 comprising a micro-reflective element is configured to reflectively scatter out the guided light portion as the plurality of directional light beams 202, or the multibeam element 234 comprising a micro-refractive element is configured to scatter out the guided light portion as the plurality of directional light beams 202 by or using refraction (i.e., refractively scatter out the guided light portion). In some embodiments, the multibeam element 234 has a size that is between twenty-five percent (25%) and two hundred percent (200%) of a size a light valve of the multiview display system 200.

According to some embodiments (e.g., as illustrated in FIG. 5), the multiview display system 200 further comprises a light source 240. The light source 240 is configured to provide light to be guided by the bar light guide 210. The light source 240 may be substantially similar to the light source 140 of the above-described backlight system 100. In particular, the light source 240 may be disposed at an end of the bar light guide 210. Further, the light source 240 may comprise a light emitting diode, in some embodiments.

The multiview display system 200 of FIG. 5 further comprises an array of light valves 250. The array of light valves 250 are configured modulate the directional light beams 202 to provide a multiview image, according to various embodiments. Dashed arrows are used in FIG. 5 to illustrate modulated directional light beams 202.

In various embodiments, different types of light valves may be employed as the light valves 250 of the light valve array including, but not limited to, one or more of liquid crystal light valves, electrophoretic light valves, and light valves based on electrowetting. In various embodiments, a size of the multibeam element 234 may be comparable to a size of a size of a light valve 250. In particular, the multibeam element size may be between about 25% and about 200% or between about fifty percent (50%) and one hundred fifty percent (150%) of the light valve size.

In accordance with yet other embodiments of the principles described herein, a method of backlight system operation is provided. FIG. 6 illustrates a method 300 of backlight system operation in an example, according to an embodiment of the principles described herein. As illustrated, the method 300 of backlight operation comprises guiding 310 light along a length of a first light guide as guided light. In some embodiments, the first light guide may be substantially similar to the first light guide 110 described above with respect to the backlight system 100. In particular, the first light guide may be a bar shaped light guide.

The method 300 of FIG. 6 further comprises extracting 320 portions of the guided light from the first light guide using light extraction elements spaced apart along the length of the first light guide to form extracted light portions. In some embodiments, the light extraction elements used in extracting 320 portions of the guided light may be substantially similar to the light extraction elements 120 of the above-described backlight system 100. In particular, extracting 320 portions of the guided light may comprise reflecting the extracted light portions at sidewalls of the light extraction elements using one or both of total internal reflection and a reflective material of the sidewalls, in some embodiments.

According to various embodiments, the method 300 further comprises providing 330 the extracted light portions to a second light guide and combining the extracted light portions within the second light guide to form combined guided light. According to some embodiments, the second light guide may be substantially similar to the second light guide 130 of the backlight system, described above. In particular, the combined guided light is guided away from light extraction elements and the first light guide by the second light guide, according to various embodiments. Further, in some embodiments, the combined guided light may be collimated according to a collimation factor by the light extraction elements.

In some embodiments, the light extraction elements may be one or both of integral to the second light guide and integral to the first light guide. The light extraction elements that are integral to the second light guide may contact an edge of the first light guide to provide light extraction at an area of contact between the light extraction elements and the first light guide. The light extraction elements that are integral to the first light guide may provide light extraction from the first light guide through apertures at respective inputs of the light extraction elements.

Thus, there have been described examples and embodiments of a backlight system, multiview display system, and method of backlight system operation, in which light extraction elements are employed to extract portions of guided light from a first light guide to form extracted light portions that are, in turn provided to a second light guide as to be combined to form combined guided light. The above-described examples are merely illustrative of some of the many specific examples that represent the principles described herein. Clearly, those skilled in the art can readily devise numerous other arrangements without departing from the scope as defined by the following claims.

1-20. (canceled)

21. A backlight system, comprising:
a first light guide configured guide light along a length of the first light guide as guided light;
a plurality of light extraction elements spaced apart along the length of the first light guide, each light extraction element of the light extraction element plurality being configured to extract a portion of the guided light from the first light guide to form extracted light portions; and
a second light guide configured to combine the extracted light portions received from the plurality of light extraction element to form combined guided light, the second light guide being further configured to guide the combined guided light along a length of the second light guide away from the plurality of light extraction elements and the first light guide,
wherein a sidewall of the light extraction element is semi-circular.

22. The backlight system of claim 21, wherein the sidewall of the light extraction element is configured to reflect the extracted light portion of the guided light toward the second light guide.

23. The backlight system of claim 22, wherein the sidewall of the light extraction element is configured to reflect the extracted light portion of the guided light according to total internal reflection.

24. The backlight system of claim 22, wherein the sidewall of the light extraction element comprises a reflective material configured to reflect the extracted light portion of the guided light.

25. The backlight system of claim 21, wherein adjacent light extraction elements of the plurality of light extraction elements are spaced apart by air gaps along the length of the first light guide.

26. The backlight system of claim 21, wherein a light extraction element of the plurality of light extraction elements is integral to the second light guide and contacts an edge of the first light guide to provide light extraction at a point of contact between the light extraction element and the first light guide.

27. The backlight system of claim 21, wherein a light extraction element of the plurality of light extraction elements is integral to the first light guide, an aperture at an input of the light extraction element providing light extraction from the first light guide.

28. The backlight system of claim 21, further comprising a light-emitting diode configured to provide light to the first light guide to be guided as the guided light, the light emitting diode being disposed at and configured to provide light through an end of the first light guide, wherein the plurality of light extraction elements is disposed on a side of the first light guide that is orthogonal to the end.

29. The backlight system of claim 21, wherein the second light guide is planar and extends over a rectangular area, the first light guide extending along an extent of an edge of the rectangular area of the second light guide.

30. The backlight system of claim 29, wherein the second light guide includes a plurality of scattering features distributed over the rectangular area and configured to scatter out a portion of the combined guided light from the second light guide as emitted light.

31. The backlight system of claim 30, wherein a scattering feature of the plurality of scattering features comprises a multibeam element, the multibeam element being configured to scatter out from the second light guide a portion of the combined guided light as a plurality of directional light beams having different principal angular directions corresponding to respective different view directions of a multiview display, the combined guided light having a predetermined collimation factor determined by the plurality of light extraction elements.

32. A multiview display system comprising:
a bar light guide configured to guide light as guided light;
a multiview backlight comprising a plate light guide and a plurality of multibeam elements; and
a plurality of light extraction elements spaced apart from one another along a side of the bar light guide and configured to extract portions of the guided light from the bar light guide to form extracted light portions and to provide the extracted light portions to the multiview backlight as combined guided light,
wherein multibeam elements of the plurality of multibeam elements are configured to scatter out the combined guided light from the plate light guide as directional light beams having directions corresponding to view directions of a multiview display,
wherein a sidewall of the light extraction element is semi-circular.

33. The multiview display system of claim 32, wherein the sidewall of the light extraction element is configured to reflect the extracted light portion of the guided light toward the plate light guide of the multiview backlight.

34. The multiview display system of claim 32, wherein a light extraction element of the plurality of light extraction elements is one or both of integral to the plate light guide and integral to the bar light guide.

35. The multiview display system of claim 32, further comprising a light source at an end of the bar light guide, the light source being configured to provide light to be guided by the bar light guide as the guided light.

36. The multiview display system of claim 32, further comprising an array of light valves configured to modulate the directional light beams to provide a multiview image.

37. A method of backlight system operation, the method comprising:
guiding light along a length of a first light guide as guided light;
extracting portions of the guided light from the first light guide to form extracted light portions using light extraction elements spaced apart along the first light guide length; and
providing the extracted light portions to a second light guide and combining the extracted light portions within the second light guide as combined guided light,
wherein the combined guided light is guided away from the light extraction elements and the first light guide by the second light guide,
wherein a sidewall of the light extraction element is semi-circular.

38. The method of backlight system operation of claim 37, wherein extracting portions of the guided light comprises reflecting the extracted light portions at the sidewalls of the light extraction elements using one or both of total internal reflection and a reflective material of the sidewalls.

39. The method of backlight system operation of claim 37, wherein light extraction elements are one or both of integral to the second light guide and integral to the first light guide, the light extraction elements that are integral to the second light guide contacting an edge of the first light guide to provide light extraction at points of contact between the light extraction elements and the first light guide, while the light extraction elements that are integral to the first light guide providing light extraction from the first light guide through apertures at inputs of the light extraction elements.
